(19) United States
(12) Patent Application Publication
(10) Pub. No.: US 2024/0262551 A1
(43) Pub. Date: Aug. 8, 2024

(54) OPPOSITELY SEALED MULTI-COMPARTMENT HEAT-SEALABLE BAG FOR FOOD STORAGE

(71) Applicant: William Cho, Reno, NV (US)

(72) Inventor: William Cho, Reno, NV (US)

(21) Appl. No.: 18/434,038

(22) Filed: Feb. 6, 2024

Related U.S. Application Data
(60) Provisional application No. 63/443,638, filed on Feb. 6, 2023.

(51) Int. Cl. B65B 29/10; B65B 31/04; B65B 51/10; B65D 33/00; B65D 81/20

(52) U.S. Cl. CPC B65B 29/10; B65B 31/04; B65B 51/10; B65D 33/00; B65D 81/2038

(57) ABSTRACT

A storage bag for particular use with home based vacuum heat sealing devices includes adjacent compartments separated by a frangible seam. A first compartment may store substantially dry foodstuffs such as meat, and/or crunchy items. A second adjacent compartment may store a liquid marinade, sauce of similar flavoring. The openings for each compartment may be provided on opposite edges of the bag so that each compartment may be independently heat sealed using a vacuum sealing device. The first compartment may additionally be evacuated. The sealed bag may be stored until ready for consumption, at which time the internal frangible seam may be broken to allow mixing of the two compartments.

### CROSS REFERENCE TO RELATED APPLICATIONS

This application claims priority to U.S. Provisional Application Ser. No. 63/443,638 filed 6 Feb. 2023, the entire contents of which are incorporated herein by reference.

### FIELD OF THE INVENTION

The present invention relates to multi-compartment sealable bags.

### BACKGROUND

The problem with household vacuum sealers is when drawing vacuum on a bag containing liquid marinade and food, the liquid marinade will be drawn out along with the air inside the bag. However, generally, it is only the meat component (or solid food component) of the mixture that is required to be vacuum sealed for preservation.

What is required is an improved heat sealable household bag that can store both vacuum sealed ingredients and non-vacuum sealed ingredients.

### SUMMARY OF ONE EMBODIMENT OF THE INVENTION

### Advantages of One or More Embodiments of the Present Invention

The various embodiments of the present invention may but do not necessarily, achieve one or more of the following advantages:
provide a multi-compartment sealable bag;
allow merging of contents of adjacent compartments without opening the bag;
allow sealing of adjacent compartments in a single sealing operation;
allow dry foods to be stored separately from wet foods while allowing mixing at the time of consumption.

These and other advantages may be realized by reference to the remaining portions of the specification, claims, and abstract.

### Brief Description of One Or More Embodiments of the Present Invention

In one embodiment, there is provided multi-compartment heat-sealable bag. The bag may comprise a first compartment having a first open end on a first edge for receiving a first material into the first compartment. The bag may also comprise a second compartment adjacent the first compartment and comprising a second open end on a second edge opposite the first edge for receiving a second material into the second compartment. An at least partially frangible seal may be provided between the first compartment and the second compartment that can be broken to allow mixing of the first material and the second material within the bag.

In one embodiment, there is provided a method for storing foodstuffs within a heat-sealable bag. The method may comprise providing a first foodstuff into a first compartment of the bag and providing a second foodstuff into a second compartment of the bag. The second compartment may be adjacent the first compartment and separated from the first compartment by an at least partially frangible seal. The method may comprise heat sealing the first compartment and the second compartment.

In one embodiment, there is provided a multi-compartment heat-sealable bag. The bag may comprise first compartment means for storing a first material. The first compartment means may comprise a first open means on a first edge for receiving a first material into the first compartment means. The bag may comprise second compartment means for storing a second material. The second compartment means may comprise a second open means on a second edge opposite the first edge for receiving a second material into the second compartment means. Frangible seal means for dividing the first compartment means from the second compartment means may be provided. The frangible seal means can be broken to allow mixing of the first material and the second material within the bag.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially depicts an embodiment of a multi-compartment heat sealable bag with a lateral partially frangible compartment seal;

FIG. 2 substantially depicts a partially frangible compartment seal featuring voids as areas of reduced seal strength; and

FIG. 3 substantially depicts an inner surface of a layer for a multi-compartment heat sealable bag with an embossed portion adjacent a first compartment opening;

FIG. 4 substantially depicts an inner surface of a layer for a multi-compartment heat sealable bag with an embossed portion extending throughout the first compartment;

FIG. 5 substantially depicts an embodiment of a multi-compartment heat sealable bag with a one way valve for evacuating a dry material compartment; and

FIG. 6 substantially depicts a method for using the multi-compartment heat sealable bag.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present inventors have realized that household food storage systems do not necessarily require all ingredients of a mixture to be vacuum sealed. Generally, meat or other solid foodstuffs require vacuum sealing so that bacteria and similar within the foodstuff cannot multiply and lead to spoilage. Other foodstuffs, particularly liquid marinades and the like, may have preservatives (natural or added) and may have been cooked or mixed in a way that naturally kills most of the bacteria that could lead to spoilage. However, it is difficult to vacuum seal marinated meats and the like using conventional household vacuum sealings systems and bags because the liquid component can be extracted into the sealing area of the bag, effecting the quality of the seal and also potentially causing damage or contamination within the vacuum sealing apparatus.

Furthermore, the present inventors have realized that meats do not require marinading for their entire shelf life, but may be combined closer to the time of consumption, typically within approximately 24 hours. However, there is currently no household heat sealable bag available that allows different food components to be stored separately and later combined.

Further still, if dried or semi-dried meats are used in combination with vacuum sealing, it may be possible to extend the shelf life even longer.

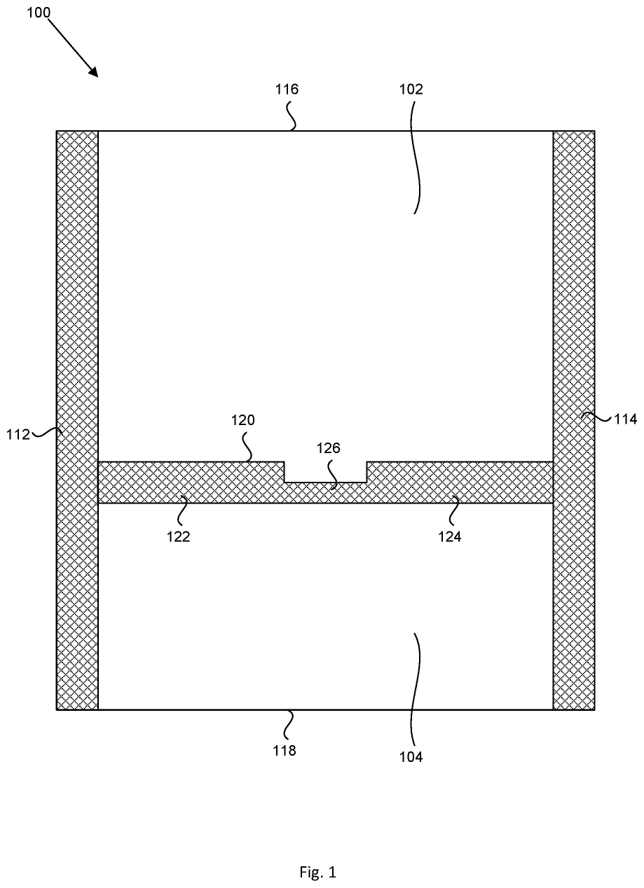

With these realizations in mind, there will be described herein a two compartment vacuum sealable bag for food storage that allows separation of different foodstuffs, particular wet and dry ingredients, and later mixture of the ingredients within the bag. As shown in FIG. 1, a bag 100 may be formed by overlaying two layers of plastic film. Each layer may itself, be comprised of multiple laminations or layers, as is known in the art. Strong side seals 112, 114 may be formed by heating sealing down each side edge of the bag 100. Part way along the length of the bag there may be formed a frangible compartment seal 120 that divides the internal volume of the bag into two separate compartments 102, 104. The compartment seal 120 may include fully sealed strong seal portions 122, 124 extending from the side seals 112, 114 and an intermediate frangible seal portion 126. The bag may be formed with heat sealable open ends 116, 118. The first opening 116 may extend for the entirety of the first edge between the first and second side seals 112, 114 or only for a portion of the first edge. Similar, the second opening 118 at a second edge of the bag opposite the first edge, may extend for the entirety of the second edge between the first and second side seals 112, 114 or only for a portion of the second edge. Each compartment may be filled with a material by the user and then heat sealed using any of a known variety of bag sealing systems. The bag sealing system may further incorporate vacuum elements for vacuum sealing one or both of the compartments. The compartments 102, 104 may be of equal size or of different sizes. The relative sizes of the compartments may be dependent on an intended use of the bag and thus each compartment may be labelled with that use.

In one embodiment, a multi-compartment bag 100 may be utilized to store foodstuffs. For example, a meat product may be stored in compartment 102 and a marinade for the meat product may be stored in compartment 104. The marinade may be filled through the open end 118 and sealed shut with minimal amount of air bubbles. The compartment 102 filled with the meat or food product that is to be marinaded may be vacuum heat sealed for long preservation and shelf life. When the user desires to use the product, the user may break the frangible seal 126 to allow that marinade and meat product to mix.

In an alternative example, the first compartment may be filled with a dry product, in particular a crunchy product while the second compartment may be filled with a wet product. The compartments may be combined just prior to serving by breaking the frangible seal, thereby allowing the food product to remain crunchy up to the time of consumption.

The bag 100 may be configured for use with a vacuum sealing machine such as the range of FoodSaver™ machines provided by Newell Brands™. These machines typically include a heat sealing bar that when pressed down upon the open end of a plastic bag will heat seal the two layers of the bag to each other. The machines can typically be operated in a heat sealing only mode, a vacuum mode only or a combined vacuum and heat sealing mode.

The frangible seal may be formed in a variety of ways. In one embodiment, the frangible seal may be made by printing an adhesive on to the inner surface of the film during manufacturing. The pattern and density of printed adhesive determines how strong the seal is. The printing could be done with a dot matrix printer, wheel, screen (like a silk screen), spray, etc.

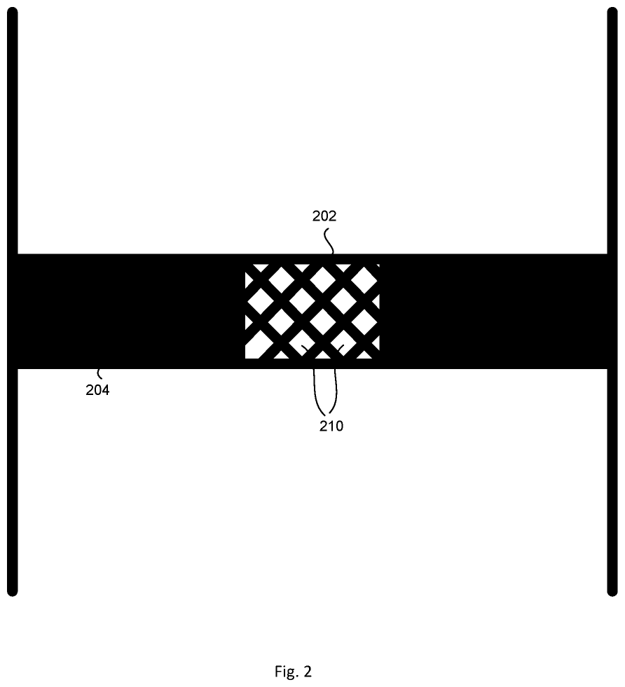

In one embodiment, the frangible seal may be formed by creating voids in the standard strong heat seal. As shown in FIG. 2, voids 210 formed in the seal reduce the sealed strength in the void section 202 relative to the non-void section 204 and dictate where the break is to occur. This method can be controlled to have a certain percentage of void for the desired frangible characteristic. For instance, 25% void area of seal would be stronger than 80% void area of seal.

In one embodiment, the frangible seal may be formed using high and low areas in a seal bar. Higher points on the seal bar would create stronger seal while the lower points on the seal bar would create weaker seal, thereby producing a frangible characteristic. By varying the pattern, depth of highs and lows, percentage of high areas and shapes of the high areas different frangible characteristics can be created.

In one embodiment, the frangible seal is made by using different sealing parameters than the non-frangible seals. The parameters may include temperature, pressure and exposure time. For example, a seal bar with a lower temperature is applied to the frangible area with less pressure and time than is applied to the non-frangible areas (edge seams) or strong seal portions of the compartment seals.

In one embodiment, the plastic film may include a layer of weaker material for the frangible seal. Specifically, a polybutene material may be used. In one specific embodiment, polybutene/polyester or any two or more blends of polyolefin may be used to create a peelable film.

The frangible seal may be broken by a force applied to the seal. In one example, the opposite layers of the bag may be grabbed by the user and pulled apart. The frangible seal, being the weakest point, should rupture first thereby allowing the contents of the first and second compartments to mix. The strength of the frangible seal may be designed so that a typical user would be able to rupture the frangible seal in this manner.

In an alternative example, the frangible seal may be broken by squeezing one or both of the compartments to increase the pressure within that compartment. In particular, a compartment containing a liquid may be squeezed to increase the liquid pressure until the frangible seal ruptures, causing the contents of the two compartments to mix.

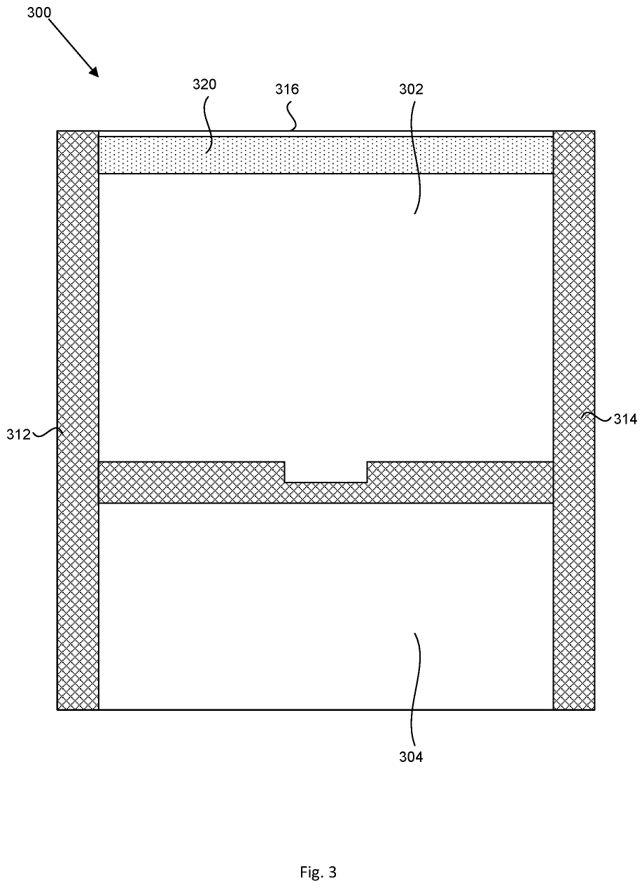

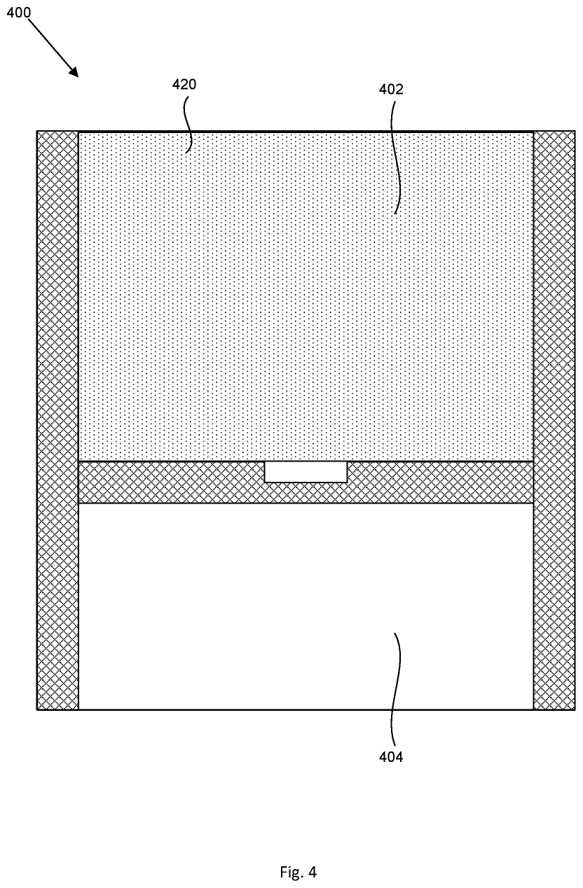

A particular example described above is to include relatively dry, solid, or particulate material into one compartment of the bag and to provide a wet material into the other compartment of the bag. The bag may be specifically designed and labelled for this purpose such that one of the compartments is a designated dry compartment and the other is a designated wet compartment. In one embodiment, the inner surfaces of the open edge of the dry compartment may be embossed with one or more grooves that facilitates vacuum sealing of this edge. However, the inner surfaces of the wet compartment may remain unembossed as such grooves can cause liquid to be drawn out of the bag and into the vacuum sealing machinery during vacuum sealing. The liquid can also be caught in the seal area and adversely affect the sealing operation. FIG. 3 shows the inner surface of one layer of a multi-compartment bag in accordance with an embodiment. The portion of the layer 300 for the dry compartment 302 includes an embossed section 320 extending between the side edges 312, 314 and adjacent the opening 316 of the first compartment. The embossing may be formed by a roller, or other suitable means apparent to the person skilled in the art. The embossing may be formed on each of the overlying layers that form the bag or on a single layer only. The wet compartment 304 does not include any embossing. FIG. 4 shows an embodiment where the embossing 420 on the inner layer has been provided throughout the first compartment portion 402. Again, no embossing is provided on the layer portion 404 intended for wet material.

In one embodiment, not illustrated, embossing may extend into the second compartment, e.g. the entire layer may embossed which may simplify manufacture. However, the second compartment, intended for liquid contents without vacuum sealing will undergo only a heat sealing operation from the vacuum sealing machine. Because of the configuration of the compartments, i.e. with openings at opposite edges of the bag, the heat sealing of the second compartment is a distinct and separate operation to the vacuum sealing of the first compartment. The embossing will therefore have minimal effect on the heat sealing of the second compartment.

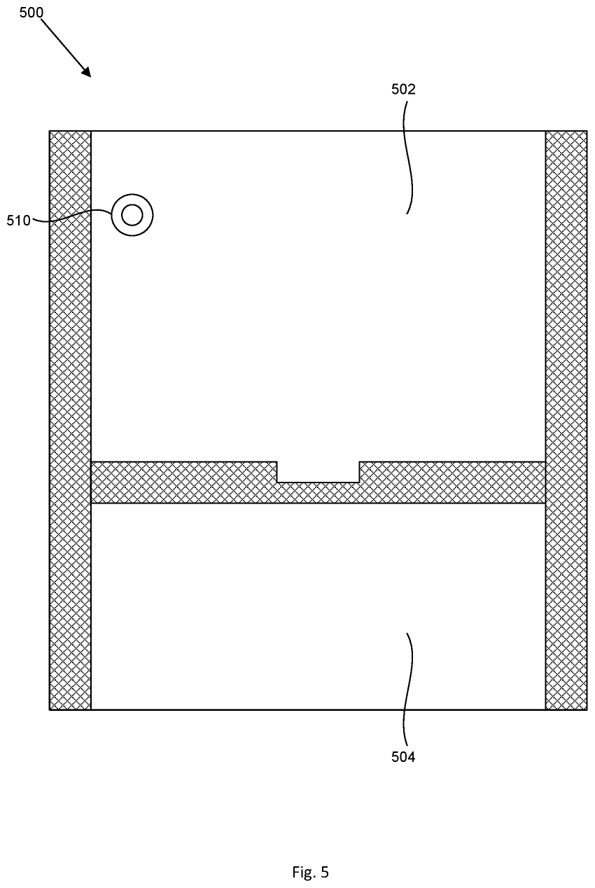

FIG. 5 shows an embodiment of a bag 500 featuring a one-way valve 510 in the dry material compartment 502. The one way valve 510 may be configured for use with certain types of vacuum sealing machines. The wet material compartment 504, not intended for vacuum sealing, does not require a one-way valve.

While a two compartment bag is shown, the person skilled in the art will recognize that a greater number of compartments may be formed with frangible seals separating any or two or more of the adjacent compartments.

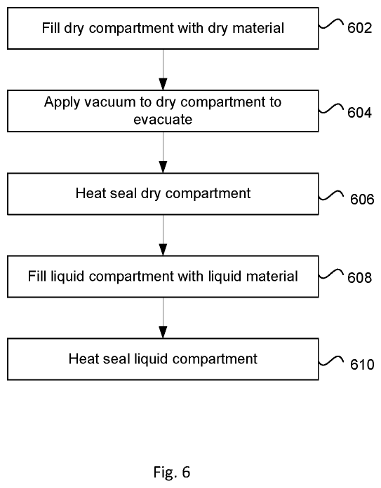

A method for using the multi-compartment bag is illustrated in FIG. 6. At step 602, the bag, e.g. bag 100 may be filled by first placing a dry product into the first compartment 102. At step 604, the open end 116 may be placed in the vacuum sealing machine and a vacuum may be applied to the open end 116 to draw air from the first compartment 102. A heat sealing operation may then be performed (step 606) on the open edge 116 to form a heat sealed seam. By this process, the first compartment is vacuum and heat sealed. A liquid, e.g. a marinade, flavored sauce, etc. may be placed into the second compartment 104 through the open end 118 to substantially fill the compartment (step 608). The open end 118 may then be inserted into the vacuum sealing machine and a heat sealing operation may be applied to the open end 404 to form a heat sealed seam (step 610). By this process, the second compartment is heat sealed. No vacuum operation is required for the second compartment, though a vacuum sealing operation may be performed if desired by the user. It will be noted by the skilled address that the compartments 102, 104 may be filled in the reverse order described herein.

With both compartments 102, 104 sealed, the bag may be stored until required, with refrigeration or freezing if necessary. To access the contents of the bag 100, the bag may be thawed if frozen until the contents of the liquid compartment 104 are again liquid. The bag may be manipulated to break the frangible seam 120. For example, the two layers of the bag may be pulled apart in the region of the seam 120 to break the frangible portion 126 of the seam. Alternatively, the liquid compartment 104 may be squeezed until the pressure forces the frangible seal 126 to rupture. Once the frangible seam is broken, the vacuum in the dry compartment 102 will draw liquid from the liquid compartment 104 as the two compartments equalize. The bag may be shaken or otherwise manipulated to mix the contents of the two compartments. Once sufficient mixing has been achieved and, optionally, sufficient marination time has elapsed, the user may open one or more of the outer edges 112, 114, 116, 118 of the bag to access the mixed contents within. One or more of the outer edges may be provided with a destructive peel seal or a tearable edge, as is known in the art, to facilitate opening of the bag.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A multi-compartment heat-sealable bag comprising:
(A) a first compartment comprising a first open end on a first edge for receiving a first material into the first compartment;
(B) a second compartment adjacent the first compartment and comprising a second open end on a second edge opposite the first edge for receiving a second material into the second compartment; and
(C) an at least partially frangible seal between the first compartment and the second compartment that can be broken to allow mixing of the first material and the second material within the bag.

2. The multi-compartment heat-sealable bag of claim 1 wherein the first open end and the second open end are heat-sealable.

3. The multi-compartment heat-sealable bag of claim 1 wherein the first compartment is configured for storing a substantially dry product, wherein the first compartment comprises an embossed portion that facilitates vacuum sealing of the bag.

4. The multi-compartment heat-sealable bag of claim 3 wherein the embossed portion is provided at the first open edge.

5. The multi-compartment heat-sealable bag of claim 3 wherein the embossed portion is provided throughout the first compartment.

6. The multi-compartment heat-sealable bag of claim 1 wherein the first compartment and the second compartment are of substantially equal size.

7. The multi-compartment heat-sealable bag of claim 1 wherein the first compartment and the second compartment are of different size.

8. A method for storing foodstuffs within a heat-sealable bag comprising:
(A) providing a first foodstuff into a first compartment of the bag;
(B) providing a second foodstuff into a second compartment of the bag, the second compartment adjacent the first compartment and separated from the first compartment by an at least partially frangible seal; and
(C) heat sealing the first compartment and the second compartment.

9. The method of claim 8 comprising breaking the at least partially frangible compartment seal and mixing the first foodstuff and the second foodstuff.

10. The method of claim 8 wherein the first foodstuff is a substantially dry foodstuff, the method comprising vacuum sealing the first compartment.

11. The method of claim 8 wherein the first foodstuff comprises a meat product and the second foodstuff comprises a liquid marinade, the method comprising vacuum sealing the first compartment.

12. The method of claim 11 comprising not vacuum sealing the second compartment.

13. A multi-compartment heat-sealable bag comprising:
(A) a first compartment means for storing a first material, the first compartment means comprising a first open means on a first edge for receiving a first material into the first compartment means;
(B) a second compartment means for storing a second material, the second compartment means comprising a second open means on a second edge opposite the first edge for receiving a second material into the second compartment means; and
(C) frangible seal means for dividing the first compartment means from the second compartment means, wherein the frangible seal means can be broken to allow mixing of the first material and the second material within the bag.

14. The multi-compartment heat-sealable bag of claim 13 wherein the first open means and the second open means are heat-sealable.

15. The multi-compartment heat-sealable bag of claim 13 wherein the first compartment means is configured for storing a substantially dry product, wherein the first compartment means comprises embossed means for facilitating vacuum sealing of the bag.

16. The multi-compartment heat-sealable bag of claim 15 wherein the embossed means is provided at the first open means.

17. The multi-compartment heat-sealable bag of claim 15 wherein the embossed means is provided throughout the first compartment means.
